(19) United States
(12) Patent Application Publication
(10) Pub. No.: US 2012/0081646 A1
(43) Pub. Date: Apr. 5, 2012

(54) LIQUID CRYSTAL DISPLAY DEVICE

(75) Inventors: Takafumi MIZOGUCHI, Atsugi (JP); Takayuki Kato, Atsugi (JP)

(73) Assignee: SEMICONDUCTOR ENERGY LABORATORY CO., LTD., Atsugi-shi (JP)

(21) Appl. No.: 13/242,799

(22) Filed: Sep. 23, 2011

(30) Foreign Application Priority Data
Sep. 30, 2010 (JP) 2010-221485

(51) Int. Cl. G02F 1/1343

(52) U.S. Cl. 349/122

(57) ABSTRACT

To provide a liquid crystal display device excellent in mechanical reliability, in which gap holding materials are arranged uniformly in a limited pixel, in an active matrix liquid crystal display device including a columnar gap holding material and liquid crystal between two substrates which face each other, at least one of wirings in a thin film transistor includes a non-expanded portion which is connected to any of electrodes of the thin film transistor and a expanded portion having a first region having the same wiring width as the non-expanded portion and a second region in contact with the first region. Further, one side of the columnar gap holding material is in contact with components on the second substrate, and the other side of the columnar gap holding material is in contact with components provided over the first substrate. Furthermore, the columnar gap holding material overlaps with the expanded portion.

### BACKGROUND OF THE INVENTION

1. Field of the Invention

The present invention relates to a liquid crystal display device. In particular, the present invention relates to an active matrix liquid crystal display device.

2. Description of the Related Art

The liquid crystal display device includes a passive matrix liquid crystal display device and an active matrix liquid crystal display device, in which liquid crystal is sandwiched between a first substrate provided with electrodes and a second substrate provided with electrodes to face the first substrate.

In the passive matrix liquid crystal display device, the electrodes are arranged in a row direction and a column direction, and regions (pixels) where the electrodes intersect with each other are provided in a grid pattern. Further, a voltage is applied to each of the electrodes in a row direction and the electrodes in a column direction at a predetermined timing, whereby in the display device, the transmittance of incident light is controlled and an arbitrary display is displayed.

Meanwhile, the active matrix liquid crystal display device has pixels including wirings called signal lines and scan lines in a grid pattern. Further, with the use of a thin film transistor (TFT) as a switching element, in each pixel, the transmittance of incident light is controlled and an arbitrary display is displayed.

For a liquid crystal display device which has been generally used, an active matrix type which is little affected by crosstalk or the like and can display a precise image has been used.

In a liquid crystal display device, in order to fix a constant space (cell gap) between two substrates with liquid crystal provided therebetween, a spherical gap holding material (spacer) or a gap holding material (spacer) which can be obtained by etching an insulating film selectively is used. Note that in this specification, the gap holding material obtained by etching an insulating film selectively is referred to as a columnar gap holding material or a columnar spacer for convenience in some cases.

The use of the columnar spacer is less affected by interruption in transmission of incident light and a more precise image can be displayed, as compared with the case where the spherical gap holding material dispersed at random is used. At that time, the position where the columnar spacer is arranged is determined in consideration of the aperture ratio of the pixel or the transmittance of incident light. Many of the columnar spacers are provided in a light-shielding region covered with a shielding film called a black matrix (BM) in which a thin film transistor, a storage capacitor, a signal line, and a scan line are provided in many cases (see Patent Document 1).

### [Reference]

[Patent Document 1] Japanese Published Patent Application No. H10-96955

### SUMMARY OF THE INVENTION

In an active matrix liquid crystal display device, as the diameter of a columnar spacer becomes larger, the columnar spacer can support a counter substrate more easily. Therefore, it can be said that mechanical strength is improved and a constant cell gap can be kept. The diameter of a columnar spacer used in a liquid crystal display device which has been generally used is specifically several tens of micrometers.

However, a thin film transistor serving as a switching element of each pixel is required to be reduced in size in order to improve the aperture ratio of the pixel. As one of methods for miniaturization, a method in which the widths of a wiring connected to an electrode provided in the thin film transistor and a wiring electrically connected to a scan line driver circuit and a signal line driver circuit are made small is given. Therefore, as the miniaturization proceeds, for example, an end portion of the columnar spacer to keep a constant space between the substrates overlaps with a step of components provided in the liquid crystal display device. Accordingly, it is difficult to obtain sufficient mechanical strength or a constant cell gap.

In view of the above, it is an object according to one embodiment of the present invention to provide a liquid crystal display device having sufficient mechanical reliability.

A liquid crystal display device according to one embodiment of the present invention includes a plurality of wirings, in which a plurality of regions where parts of the wirings are expanded are provided and spacers are arranged in the expanded regions.

In an active matrix liquid crystal display device according to one embodiment of the present invention, a wiring connected to an electrode which forms a thin film transistor includes an expanded portion having a first region and a second region in contact with the first region. Further, a columnar gap holding material that can be provided by etching an insulating film selectively overlaps with the expanded portion. In this specification, the first region and the second region are collectively referred to as the expanded portion (the expanded portion of the wiring). That is, the wiring electrically connected to the electrode in the thin film transistor includes the expanded portion and a non-expanded portion, and the wiring width of the expanded portion is wider than that of the non-expanded portion. Further, the first region is a region having the same wiring width as the non-expanded portion, and the second region is a region which projects from the first region. Furthermore, the plurality of columnar gap holding materials are provided, and the number of the columnar gap holding materials is equal to the number of the expanded portions.

When the fact that an insulating film or the like is provided over the expanded portion of the wiring is considered, an active matrix liquid crystal display device according to one embodiment of the present invention at least includes a first substrate including a plurality of thin film transistors and a plurality of pixel electrodes; a second substrate including at least a counter electrode; a plurality of columnar gap holding materials between the first substrate and the second substrate; and liquid crystal sandwiched between the first substrate and the second substrate, in which at least one of wirings connected to electrodes in the plurality of thin film transistors includes a plurality of non-expanded portions which are connected to any of electrodes of the plurality of thin film transistors and a plurality of expanded portions having a first region having the same wiring width as the plurality of non-expanded portions and a second region in contact with the first region, in which one side of the plurality of columnar gap holding materials is in contact with components provided on the second substrate, in which the other side of the plurality of columnar gap holding materials is in contact with components provided over the first substrate, and in which the plurality of columnar gap holding materials overlap with the plurality of expanded portions.

Further, the expanded portion of the wiring connected to the electrode provided in the thin film transistor includes the first region and the second region expanded along an edge of the top surface of the columnar gap holding material. Accordingly, the diameter of the columnar gap holding material can be increased with high uniformity. That is, an active matrix liquid crystal display device of another embodiment of the present invention at least includes a first substrate including a plurality of thin film transistors and a plurality of pixel electrodes; a second substrate including at least a counter electrode; a plurality of columnar gap holding materials between the first substrate and the second substrate; and liquid crystal sandwiched between the first substrate and the second substrate, in which at least one of wirings connected to electrodes in the plurality of thin film transistors includes a plurality of non-expanded portions which are connected to any of electrodes of the plurality of thin film transistors and a plurality of expanded portions having a first region having the same wiring width as the plurality of non-expanded portions and a second region in contact with the first region and expanded along an edge of the top surface of the columnar gap holding material, in which one side of the plurality of columnar gap holding materials is in contact with components provided on the second substrate, in which the other side of the plurality of columnar gap holding materials is in contact with components provided over the first substrate, and in which the plurality of columnar gap holding materials overlap with the plurality of expanded portions.

Furthermore, the expanded portion of the wiring connected to the electrode provided in the thin film transistor may include a third region opposite to the second region and in contact with the first region, in addition to the first region and the second region. That is, in this embodiment, the expanded portion of the wiring includes the first region, the second region, and the third region. Note that the wiring includes the expanded portion and the non-expanded portion, and the wiring width of the expanded portion is wider than that of the non-expanded portion as described above. Further, the third region is a region which projects from the first region having the same wiring width as the non-expanded portion. Furthermore, the plurality of columnar gap holding materials are provided, and the number of the columnar gap holding materials is equal to the number of the expanded portions.

An active matrix liquid crystal display device according to another embodiment of the present invention at least includes a first substrate including a plurality of thin film transistors and a plurality of pixel electrodes; a second substrate including at least a counter electrode; a plurality of columnar gap holding materials between the first substrate and the second substrate; and liquid crystal sandwiched between the first substrate and the second substrate, in which at least one of wirings connected to electrodes in the plurality of thin film transistors includes a plurality of non-expanded portions which are connected to any of electrodes of the plurality of thin film transistors and a plurality of expanded portions having a first region having the same wiring width as the plurality of non-expanded portions and a second region in contact with the first region, and a third region opposite to the second region and in contact with the first region, in which one side of the plurality of columnar gap holding materials is in contact with components provided on the second substrate, in which the other side of the plurality of columnar gap holding materials is in contact with components provided over the first substrate, and in which the plurality of columnar gap holding materials overlap with the plurality of expanded portions.

Further, in the above embodiment, the expanded portion of the wiring connected to the electrode provided in the thin film transistor includes the first region, the second region and the third region expanded along an edge of the top surface of the columnar gap holding material. Accordingly, the diameter of the columnar gap holding material can be increased with high uniformity. That is, an active matrix liquid crystal display device according to another embodiment of the present invention at least includes a first substrate including a plurality of thin film transistors and a plurality of pixel electrodes; a second substrate including at least a counter electrode; a plurality of columnar gap holding materials between the first substrate and the second substrate; and liquid crystal sandwiched between the first substrate and the second substrate, in which at least one of wirings connected to electrodes in the plurality of thin film transistors includes a plurality of non-expanded portions which are connected to any of electrodes of the plurality of thin film transistors and a plurality of expanded portions having a first region having the same wiring width as the plurality of non-expanded portions, a second region in contact with the first region and expanded along an edge of the top surface of the columnar gap holding material, and a third region opposite to the second region and in contact with the first region and expanded along an edge of the top surface of the columnar gap holding material, in which one side of the plurality of columnar gap holding materials is in contact with components provided on the second substrate, in which the other side of the plurality of columnar gap holding materials is in contact with components provided over the first substrate, and in which the plurality of columnar gap holding materials overlap with the plurality of expanded portions.

The thin film transistor in the above liquid crystal display device may be a bottom-gate transistor in which a semiconductor film to be a channel formation region is over and overlaps with a gate electrode with a gate insulating film interposed therebetween or a top-gate transistor in which a gate electrode is over and overlaps with a semiconductor film to be a channel formation region with the gate insulating film interposed therebetween. Furthermore, in the above bottom-gate thin film transistor or the above top-gate thin film transistor, the above expanded portion can be provided in any of a gate wiring including a gate electrode, a source wiring including a source electrode, or a drain wiring including a drain electrode.

It is preferable that the columnar gap holding material provided in a liquid crystal display device according to one embodiment of the present invention be a cylindrical gap holding material having a circle top shape or a prismatic gap holding material having a polygonal top shape, for example.

According to one embodiment of the present invention, a liquid crystal display device excellent in mechanical reliability, in which gap holding materials are arranged uniformly in a limited pixel, can be provided.

### BRIEF DESCRIPTION OF THE DRAWINGS

FIGS. 1A and 1B illustrate a block diagram of a liquid crystal display device and a circuit configuration of a pixel, respectively.

FIGS. 2A to 2C are top views of a configuration of a pixel in a liquid crystal display device and an expanded portion provided in a wiring.

FIGS. 3A and 3B are cross-sectional views of a configuration of a liquid crystal display device.

FIGS. 4A and 4B are top views of a configuration of a pixel in a liquid crystal display device and an expanded portion provided in a wiring of the thin film transistor.

FIGS. 5A to 5C are top views of a configuration of a pixel in a liquid crystal display device and an expanded portion provided in a wiring of the thin film transistor.

FIGS. 6A to 6D are top views of a variety of examples of an expanded portion provided in a wiring of a thin film transistor.

### DETAILED DESCRIPTION OF THE INVENTION

Embodiments of the present invention will be described below in detail with reference to the accompanying drawings. However, the present invention is not limited to the following description and it is easily understood by those skilled in the art that the mode and details can be variously changed without departing from the scope and spirit of the present invention. Therefore, the present invention should not be construed as being limited to the description of the embodiments below. In describing structures of the present invention with reference to the drawings, the same reference numerals are used in common for the same portions in different drawings. The same hatching pattern is applied to similar parts, and the similar parts are not especially denoted by reference numerals in some cases. Note that the size, the layer thickness, or the region of each structure illustrated in each drawing is exaggerated for clarity in some cases. Therefore, the present invention is not necessarily limited to such scales illustrated in the drawings.

When a stack of layers (or electrodes) included in a thin film transistor is illustrated in the drawings, in some cases, an end portion of a lower layer which protrudes from an end portion of an upper layer is not illustrated in a top view of the thin film transistor for convenience.

Note that when it is described that “A and B are connected to each other”, the case where A and B are electrically connected to each other, and the case where A and B are directly connected to each other are included therein. Here, each of A and B corresponds to an object (e.g., a device, an element, a circuit, a wiring, an electrode, a terminal, a conductive film, or a layer).

Note that a voltage refers to a difference between potentials of two points, and a potential refers to electrostatic energy (electric potential energy) of a unit charge at a given point in an electrostatic field. Note that in general, a difference between a potential of one point and a reference potential is merely called a potential or a voltage, and a potential and a voltage are used as synonymous words in many cases. Thus, in this specification, a potential may be rephrased as a voltage and a voltage may be rephrased as a potential unless otherwise specified.

Functions of a “source” and a “drain” are sometimes interchanged with each other when the direction of current flowing is changed in circuit operation, for example. Therefore, the terms “source” and “drain” can be used to denote the drain and the source, respectively, in this specification.

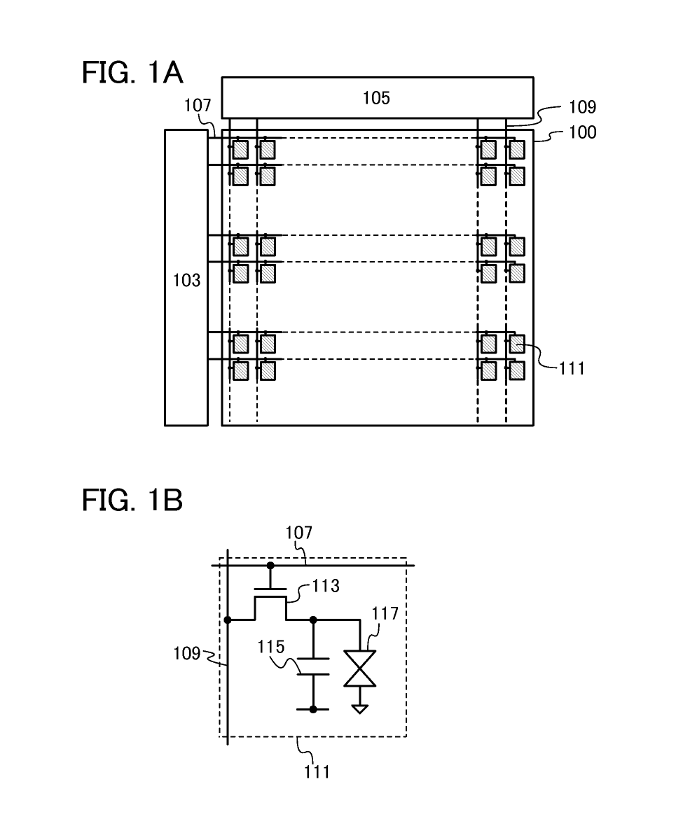

A liquid crystal display device according to one embodiment of the present invention will be described. FIG. 1A illustrates a structure example of a liquid crystal display device. The liquid crystal display device illustrated in FIG. 1A includes a pixel portion 100, a scan line driver circuit 103, a signal line driver circuit 105, m (m is a natural number) scan lines 107 (also referred to as gate wirings 107) each of which are arranged in parallel (or substantially in parallel) and whose potentials are controlled by the scan line driver circuit 103, and n (n is a natural number) signal lines 109 (also referred to as source wirings 109) each of which are arranged in parallel (or substantially in parallel) and whose potentials are controlled by the signal line driver circuit 105. Further, the pixel portion 100 includes a plurality of pixels 111 arranged in matrix (of m rows and n columns). Each of the scan lines 107 is electrically connected to the n pixels in the corresponding row among the plurality of pixels arranged in m rows and n columns in the pixel portion 100. Each of the signal lines 109 is electrically connected to the m pixels in the corresponding column among the plurality of pixels arranged in the m rows and the n columns.

FIG. 1B is an example of a circuit diagram of the pixel 111 included in the liquid crystal display device illustrated in FIG. 1A. The pixel 111 illustrated in FIG. 1B includes a thin film transistor 113 in which a gate electrode is electrically connected to the scan line 107 and a source electrode is electrically connected to the signal line 109, a storage capacitor 115 in which one electrode is electrically connected to the drain electrode of the thin film transistor 113 and the other electrode is electrically connected to a wiring (also referred to as a capacitor line) which supplies a constant potential, and a liquid crystal element 117 in which one electrode (also referred to as a pixel electrode) is electrically connected to the drain electrode of the thin film transistor 113 and the one electrode of the storage capacitor 115 and the other electrode (also referred to as a counter electrode) is electrically connected to the wiring supplying a fixed potential.

The liquid crystal element 117 is an element which controls transmission of light by optical modulation action of liquid crystal which is sandwiched between a first substrate over which the thin film transistor 113 and the pixel electrode are provided and a second substrate provided with the counter electrode. Note that optical modulation action of liquid crystal is controlled by an electric field applied to liquid crystal (including a horizontal electric field, a vertical electric field, and an oblique electric field). In the case of a transmissive liquid crystal display device, the light is transmitted from an irradiation light source which is referred to as a backlight or a side light. In the case of a reflective liquid crystal display device, the light is external light such as sunlight or an interior lamp by a reflective electrode. In the case of a semi-transmissive liquid crystal display device, the light is both of them. Further, the first substrate and the second substrate between which liquid crystal is sandwiched adhere to each other with sealant which is a visible light curable resin, an ultraviolet curable resin, or a thermosetting resin.

Further, in this specification, optical modulation action of liquid crystal is controlled by the pixel electrode provided over the first substrate and the counter electrode provided with the second substrate; however, for example, optical modulation action of liquid crystal may be controlled by the pixel electrode provided only for the first substrate, as an IPS (In-Plane Switching) driving liquid crystal display device.

It is preferable that all thin film transistors 113 provided over the same substrate have the same polarity because the number of steps can be reduced.

Therefore, in this embodiment, in addition to the thin film transistors 113 provided in the pixel portion 100, the thin film transistors provided in the scan line driver circuit 103 and in the signal line driver circuit 105 are n-channel transistors. Further, a potential difference between the storage capacitors 115 can be made to be equal to a potential difference between the liquid crystal elements 117.

The scan line driver circuit 103 and the signal line driver circuit 105 each include a logic circuit portion, and a switch portion or a buffer portion. Further, the scan line driver circuit 103 and the signal line driver circuit 105 may be provided over the first substrate over which the thin film transistor 113 is provided. Alternatively, part or all of the scan line driver circuit 103 and the signal line driver circuit 105 may be mounted using a semiconductor device such as an IC.

Note that the details of the material, the shape, or the like is omitted here; however, in addition to the above-described structure, the liquid crystal display device according to one embodiment of the present invention may have a structure used for a liquid crystal display device which has been generally used, such as an irradiation light source, a polarizing plate, a retardation plate, a colored layer which is necessary for color display (a color filter), or a light-blocking film (a black matrix).

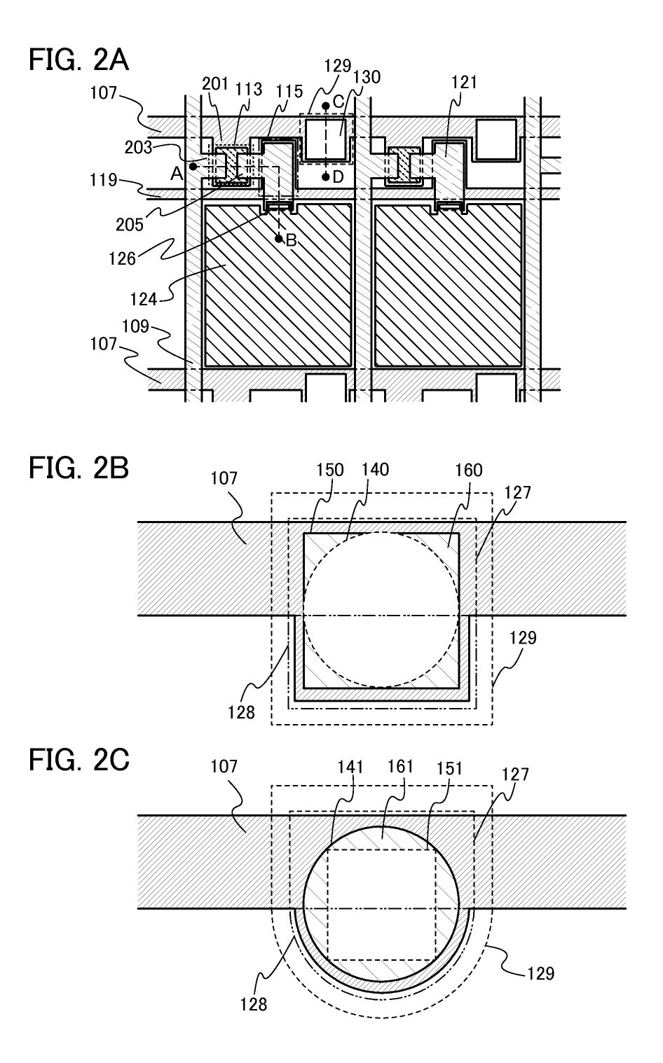

Next, FIG. 2A illustrates an example of a specific structure of the pixel 111. FIG. 2A illustrates two pixels.

In FIG. 2A, the m gate wirings 107 (including gate electrodes 201) are arranged to extend in a direction substantially orthogonal (the horizontal direction in the drawing) to the source wirings 109 (including source electrodes 203) and to be apart from each other. The n source wirings 109 (including the source electrodes 203) are arranged in parallel to each other (extended in the vertical direction in the drawing) and apart from each other. The m gate wirings 107 and m capacitor wirings 119 are electrically connected to the scan line driver circuit 103 (see FIG. 1A), and the n source wirings 109 are electrically connected to the signal line driver circuit 105 (see FIG. 1A).

Further, each of the capacitor wirings 119 is arranged adjacent to each of the m gate wirings 107 and is extended in a direction parallel or substantially parallel to the gate wiring 107. That is, each of the capacitor wirings 119 is extended in a direction substantially orthogonal to the source wiring 109 (the horizontal direction in the drawing). The storage capacitor 115 is surrounded by a dashed-dotted line in FIG. 2A and includes the capacitor wiring 119 and a drain wiring 121 (including a drain electrode 205) using a gate insulating film as a dielectric. A pixel electrode 124 is electrically connected to the drain wiring 121 through an opening 126.

The thin film transistors 113 which are electrically connected to the pixel electrode 124 are surrounded by a dotted line. The plurality of thin film transistors 113 are arranged in matrix (an upper-left portion of the pixel in FIG. 2A).

In the gate wiring 107 of each pixel, an expanded portion 129 is surrounded by a dotted line. FIG. 2B illustrates an enlarged view of the expanded portion 129. The expanded portion 129 includes a first region 127 and a second region 128 which is in contact with the first region 127. That is, the gate wiring 107 includes the expanded portion 129 and a non-expanded portion which is electrically connected to the gate electrode 201 of the thin film transistor 113. Note that the wiring width of the expanded portion 129 is wider than that of the non-expanded portion. Further, the first region 127 is a region having the same wiring width as the non-expanded portion and, the second region 128 is a region which projects from the first region 127. Note that, in this specification, the gate electrode 201 is a region which projects from the non-expanded portion of the gate wiring 107 having the same wiring width as the first region 127 of the expanded portion 129.

In addition, a columnar gap holding material 130 overlaps so as to be within the region of the expanded portion 129. That is, the columnar gap holding material 130 overlaps with the expanded portion 129 of the gate wiring 107 and the gap holding material 130 does not protrude from the gate wiring 107. Further, although the plurality of columnar gap holding materials 130 are provided, the number of the columnar gap holding materials 130 is preferably equal to the number of the expanded portions 129.

Note that although not shown, various components such as a gate insulating film and an interlayer insulating film to be formed in the manufacturing process are provided over the gate wiring 107; therefore, more precisely, the columnar gap holding material 130 on the substrate side on which the thin film transistor 113 is provided is formed in contact with the components over the expanded portion 129. Further, the columnar gap holding material 130 may be formed in contact with the expanded portion 129. In the mode illustrated in FIG. 2A, the gap holding materials 130 are arranged in each pixel; however, the present invention is not limited thereto and the gap holding materials 130 may be arranged at regular intervals. For example, the expanded portions 129 may be provided in only pixels corresponding to red (R) of a color filter of red (R), green (G), and blue (B) which are necessary for full color display, and the gap holding materials 130 may be arranged in the expanded portions 129.

The diameter (or the length of one side) of a columnar gap holding material used for a liquid crystal display device which has been generally used is about several tens of micrometers. In the liquid crystal display device, in order to arrange the columnar gap holding material over a flat surface without a step so as to obtain sufficient mechanical strength, expansion of the width of part of the wiring is preferable to expansion of the width of all of the wiring; thus, the columnar gap holding material can be arranged without reducing an aperture ratio.

Therefore, although the expanded portion 129 may have any shape, in order to arrange the gap holding material 130 to obtain sufficient mechanical reliability without reducing the aperture ratio, the expanded portion 129 (particularly, the second region 128) is preferably expanded along an edge of the top surface of the columnar gap holding material 130.

This is because, in the case where the expanded portion 129 (particularly, the second region 128) is expanded along an edge of the top surface of the columnar gap holding material 130, a region (margin) which can be used as a region where the columnar gap holding material 130 is placed can be set widely and the bonding margin in all directions over a plane surface can be effectively selected, as compared with the case where the width of the wiring is expanded so that the expanded portion 129 and the top surface of the columnar gap holding material 130 have different shapes. Therefore, the liquid crystal display device having a high mechanical strength can be manufactured with high yield.

As examples, (i) the case where the second region 128 which projects from the first region 127 has a quadrilateral shape as in FIG. 2B which is an enlarged view of FIG. 2A and (ii) the case where the second region 128 which projects from the first region 127 has a semicircular shape as in FIG. 2C will be described.

In the above case (i), as compared with a cylindrical gap holding material 140 having a circle top shape shown by a dotted line, a prismatic gap holding material 150 having a quadrilateral top shape whose length of one side is equal to the length of the diameter of the circle shown by a solid line can widely obtain a shaded portion (margin) 160 as the columnar gap holding material. Therefore, when the gap holding material 150 is used, mechanical strength of the liquid crystal display device can be further improved.

In the above case (ii), as compared with a prismatic gap holding material 151 having a quadrilateral top shape shown by a dotted line, a cylindrical gap holding material 141 having a circle top shape whose diameter which is equal to the length of the diagonal line of the quadrilateral shown by a solid line can widely obtain a shaded portion (margin) 161 as the columnar gap holding material. Therefore, when the cylindrical gap holding material 141 is used, mechanical strength of the liquid crystal display device can be further improved.

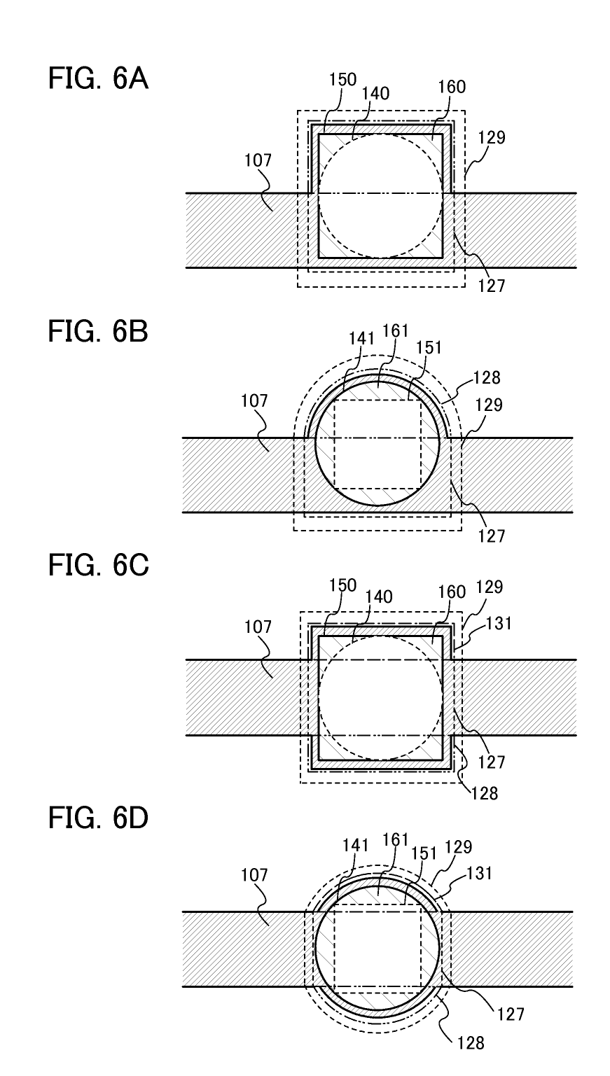

Note that in FIGS. 2B and 2C, the expanded portion 129 (particularly, the second region 128) is provided in the same direction as the gate electrode 201 of the thin film transistor 113; however, the expanded portion 129 is not limited to this embodiment. For example, as in FIGS. 6A and 6B, the expanded portion 129 may include the first region 127 and the second region 128 opposite to the gate electrode 201 of the thin film transistor 113. Further, as in FIGS. 6C and 6D, the expanded portion 129 may include the first region 127, the second region 128, and a third region 131 opposite to the second region 128 and in contact with the first region 127. The third region 131 is a region which projects from the first region 127 having the same wiring width as the non-expanded portion, as in the second region 128. In the modes described here, the shape of the pixel electrode 124 can be changed as appropriate in accordance with the expanded portion 129.

As described above, the second region 128 and the third region 131 are expanded along an edge of the top surface of the columnar gap holding material 130, whereby the top surface of the columnar gap holding material 130 is approximately similar to the top surface of the expanded portion 129. Therefore, in a region generated between the top surface of the columnar gap holding material 130 and the expanded portion 129 (at least a region generated between part of the top surface of the columnar gap holding material 130 and the second region 128), a distance between the edge of the top surface of the columnar gap holding material 130 and the edge of the expanded portion 129 is approximately the same. Note that the columnar gap holding material 130 preferably overlaps with the periphery of the expanded portion 129 and the case where the columnar gap holding material 130 is shifted within the bonding margin and overlaps with the expanded portion 129 is included. Therefore, the distance between an edge of the top surface of the columnar gap holding material 130 and an edge of the expanded portion 129 may be different.

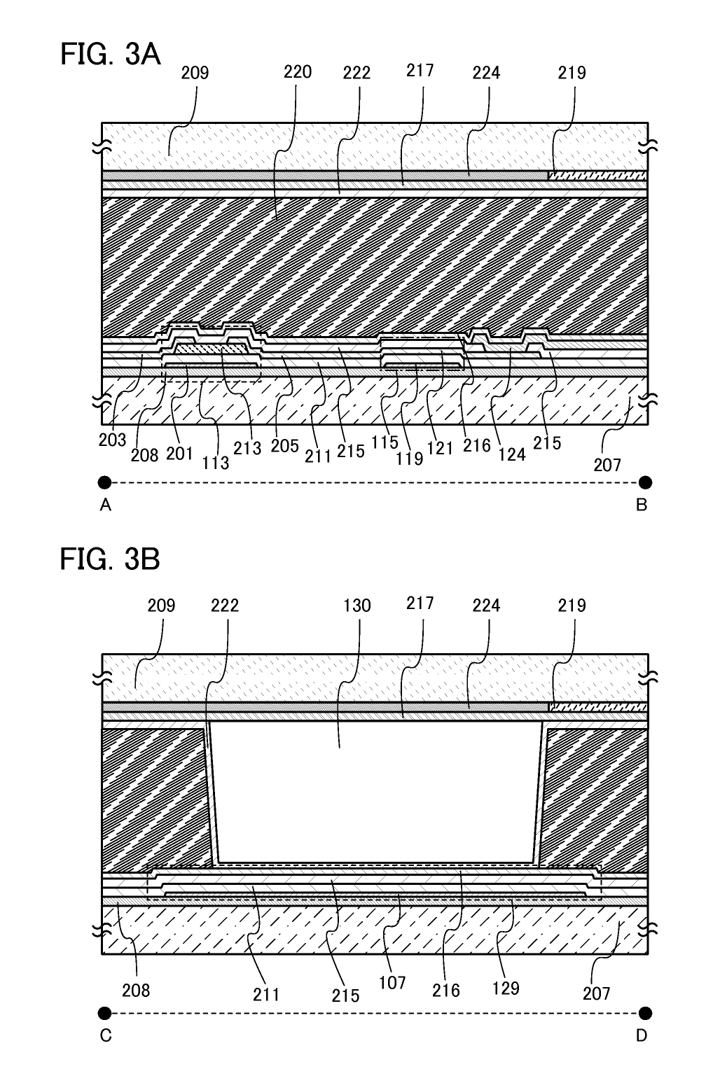

As a cross-sectional structure of the liquid crystal display device according to one embodiment of the present invention, the cross-sectional structure of the pixel 111 will be described. FIG. 3A illustrates a cross-sectional view taken along A-B in FIG. 2A, and FIG. 3B illustrates a cross-sectional view taken along C-D in FIG. 2A.

The thin film transistor 113 is a bottom-gate thin film transistor in which a semiconductor film 213 overlaps with a gate electrode 201 with a gate insulating film 211 interposed therebetween, in which a base insulating film 208 is provided over a first substrate 207, and includes the gate electrode 201, the gate insulating film 211, the semiconductor film 213, the source electrode 203, and the drain electrode 205.

The gate electrode 201, the source electrode 203, and the drain electrode 205 are preferably formed using conductive films. The base insulating film 208 and the gate insulating film 211 are preferably formed using silicon insulating films (oxide or nitride of silicon). It is preferable that the semiconductor film 213 be formed using a silicon semiconductor film having a channel formation region.

Without limitation to the thin film transistor 113, the components of the liquid crystal display device according to one embodiment of the present invention are formed by a dry method such as an evaporation method, a sputtering method, or a CVD method or a wet method such as spin coating, dip coating, spray coating, or a droplet discharge method (e.g., an inkjet method, screen printing, or offset printing). An etching method (dry etching or wet etching) may be employed as needed to process into a desired pattern. Note that when the thin film transistor 113 is manufactured, the components preferably have tapered shapes in consideration of coverage of the thin film. In order to form the components to be tapered, etching is performed while the resist mask is made to recede, by a photolithography step or the like.

An insulating film 215 is provided in contact with the semiconductor film 213 to cover the thin film transistor 113.

Further, the storage capacitor 115 shown by a dotted line includes the gate insulating film 211, as a dielectric, interposed between the capacitor wiring 119 and the drain wiring 121 including the drain electrode 205, as described above. The capacitor wiring 119 is formed under the same condition and in the same process as the gate electrode 201; thus, the capacitor wiring 119 has the same layer structure as the gate electrode 201. That is, the storage capacitor 115 is not necessary to be manufactured separately from the thin film transistor 113 and can be formed through the procedure for manufacturing the thin film transistor 113 by being processed into a desired pattern.

The opening 126 is formed at a predetermined position of the insulating film 215 through a photolithography step and by an etching method, and the pixel electrode 124 is formed through the opening 126. The pixel electrode 124 is electrically connected to the drain wiring 121 including the drain electrode 205. Note that the pixel electrode 124 is formed using a light-transmitting conductive film.

An interlayer insulating film 216 is formed to cover the thin film transistor 113, the storage capacitor 115, and the pixel electrode 124. The interlayer insulating film 216 also serves as an alignment film for aligning liquid crystal 220 which is to be described later. Note that in the case of using a blue phase for the liquid crystal or the like, the interlayer insulating film 216 is not necessarily provided if the alignment film is not necessary.

The liquid crystal display device according to one embodiment of the present invention can perform monochrome display or color display. In particular, in the case of full-color display, a color filter 219 is provided on a second substrate 209 (a counter substrate 209) as in FIG. 3A. It is preferable that the color filter 219 be formed using a material through which red (R) light, green (G) light, and blue (B) light is transmitted. In the case of mono-color display except monochrome display, it is only necessary to use a material through which light of at least one color is transmitted, and it is not necessary to provide a color filter with a different color in every pixel.

Specifically, the color filter 219 is preferably formed above the pixel electrode 124 over the first substrate 207. As an example, as in FIG. 3A, the color filter 219 is preferably formed between the second substrate 209 and a counter electrode 217 to face the pixel electrode 124. Note that in FIG. 3A, the color filter 219 is formed on the second substrate 209; however, the color filter 219 may be formed on the first substrate 207 side. Further, the thickness of the color filter 219 is preferably controlled as appropriate in consideration of the relationship between the concentration of the coloring material to be included and the transmittance of light so as to obtain optimum thickness.

The first substrate 207 and the second substrate 209 between which the liquid crystal 220 is sandwiched adhere to each other with sealant (not shown). The liquid crystal 220 is not particularly limited; it is preferable that a liquid crystal material of Twist Nematic mode (TN mode) be used, for example. In order to form the liquid crystal 220, it is preferable that a dispenser method (a dropping method) or an injection method in which the liquid crystal 220 is injected by using capillary action or the like after the first substrate 207 and the second substrate 209 are attached to each other be used. Further, the alignment film is subjected to a rubbing process, whereby the alignment of the liquid crystal is easily performed. Therefore, the rubbing process is preferably performed. Note that the interlayer insulating film 216 provided over the first substrate 207 and an insulating film 222 provided on the second substrate 209 serve as the alignment films.

A light-shielding film 224 called a black matrix is provided on the second substrate 209 in order to shield from light a region over the thin film transistor 113 and the storage capacitor 115 provided over the first substrate 207 and to prevent light leakage. Further, the light-shielding film 224 is formed using a material that reflects or absorbs light and has a light-blocking property.

Furthermore, as well as the pixel electrode 124, the counter electrode 217 which controls the alignment of the liquid crystal 220 by the potential is provided on the second substrate 209 (the counter substrate 209). The counter electrode 217 is formed using a light-transmitting conductive film.

Although not shown, the counter electrode 217, the light-blocking film 224, and the color filter 219 preferably have tapered shapes.

As in FIG. 3B, the columnar gap holding material 130 is formed as follows: an insulating film is formed on the second substrate 209 on which the counter electrode 217, the light-blocking film 224, and the color filter 219 are formed and is selectively etched to have a tapered shape. Therefore, the length of the second substrate 209 side is longer than the length of the first substrate 207 side; however, the present invention is not limited thereto. Further, when the insulating film formed on the second substrate 209 is selectively etched to have a tapered shape, an edge portion on the second substrate 209 side of the columnar gap holding material 130 is preferably etched not to overlap with a step of the components (the counter electrode 217, the light-blocking film 224, and the color filter 219) which are provided on the second substrate 209.

The columnar gap holding material 130 overlaps with a portion other than a step of the expanded portion 129 (the expanded portion 129), and the columnar gap holding material 130 on the first substrate 207 side is in contact with the gate insulating film 211, the insulating film 215, and the interlayer insulating film 216 which are provided over the gate wiring 107 and the expanded portion 129, with the insulating film 222 interposed between the columnar gap holding material 130 and the stack of the gate insulating film 211, the insulating film 215, and the interlayer insulating film 216.

Alternatively, the columnar gap holding material 130 may be formed as follows: an insulating film is formed over the expanded portion 129 of the first substrate 207 and is selectively etched to have a tapered shape. At that time, in the columnar gap holding material 130, the length of the first substrate 207 side is longer than the length of the second substrate 209 side. A cell gap between the first substrate 207 and the second substrate 209 is not particularly limited; however, the cell gap is preferably greater than or equal to 1 μm and less than or equal to 20 μm. Further, the thicknesses of all the gap holding materials 130 are not necessarily the same and the gap holding materials 130 may have a plurality of thicknesses. That is, the above gap holding material 130 and a gap holding material smaller than the above gap holding material 130 may be included at the same time. In this specification, the thickness of the cell gap refers to the length (film thickness) of a thickest part of the layer including the liquid crystal 220.

Although not shown in FIGS. 3A and 3B, a polarizing member is formed as appropriate outside the first substrate 207 (opposite side to the liquid crystal 220) and outside the second substrate 209 (opposite side to the liquid crystal 220), and an irradiation light source such as a backlight is formed as appropriate outside the polarizing member formed outside the first substrate 207. Further, an optical film such as a retardation plate (also including a retardation film) or an anti-reflection plate (also including an anti-reflection film) or the like is formed as appropriate between the irradiation light source and the polarizing member formed outside the second substrate 209. Thus, a transmissive liquid crystal display device according to one embodiment of the present invention can be manufactured. Further, when a reflective electrode is used instead of the irradiation light source, a reflective liquid crystal display device according to one embodiment of the present invention can be manufactured. Furthermore, when the above components are used, a transflective liquid crystal display device according to one embodiment of the present invention can be manufactured.

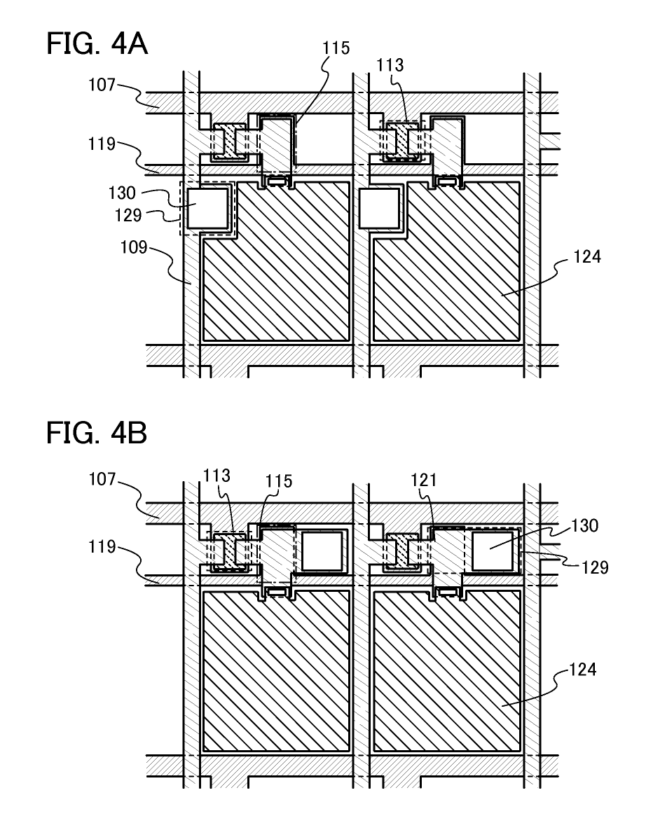

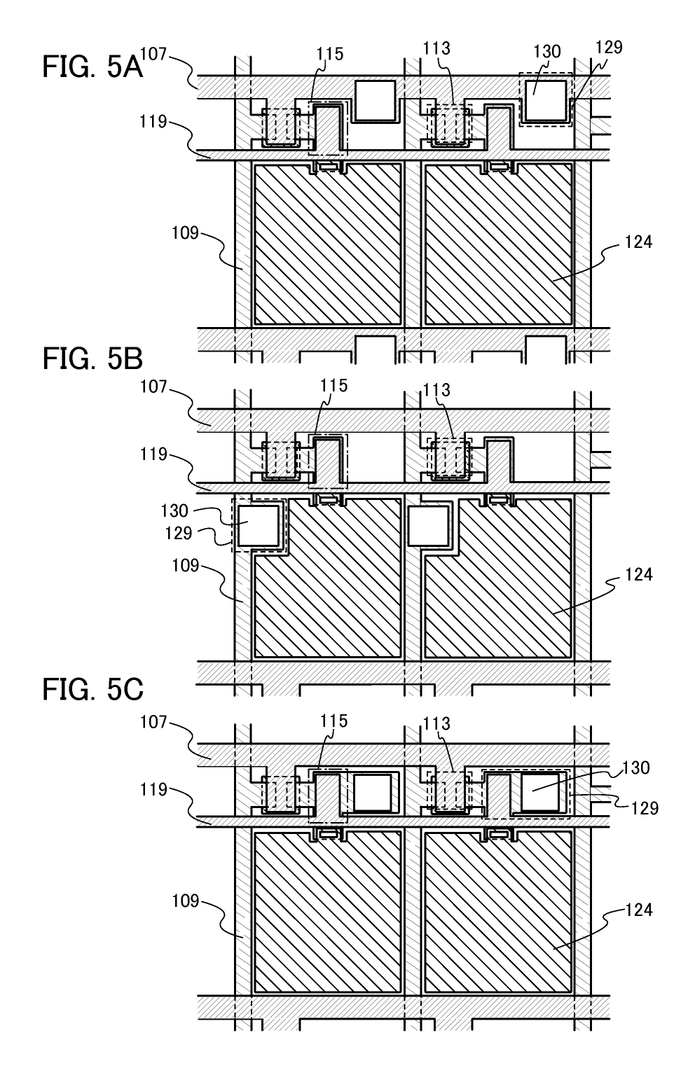

The liquid crystal display device as described above has a bottom-gate thin film transistor as the thin film transistor 113, in which the expanded portion 129 is formed over the gate wiring 107 and the columnar gap holding material 130 is formed over the expanded portion 129. However, instead of a bottom-gate thin film transistor, a top-gate transistor in which the gate electrode 201 is formed over the semiconductor film 213 with the gate insulating film 211 interposed therebetween may be used as the thin film transistor 113. Further, the expanded portion 129 in which the columnar gap holding material 130 is placed may be formed not in the gate wiring 107 but in the source wiring 109 or the drain wiring 121. That is, the present invention is not limited to (1) an embodiment in which the thin film transistor 113 is a bottom-gate thin film transistor and the expanded portion 129 is formed in the gate wiring 107 as described above, and as another embodiment of the present invention, (2) an embodiment in which the thin film transistor 113 is a bottom-gate thin film transistor and the expanded portion 129 is formed in the source wiring 109, (3) an embodiment in which the thin film transistor 113 is a bottom-gate thin film transistor and the expanded portion 129 is formed in the drain wiring 121, (4) an embodiment in which the thin film transistor 113 is a top-gate thin film transistor and the expanded portion 129 is formed in the gate wiring 107, (5) an embodiment in which the thin film transistor 113 is a top-gate thin film transistor and the expanded portion 129 is formed in the source wiring 109, and (6) an embodiment in which the thin film transistor 113 is a top-gate thin film transistor and the expanded portion 129 is formed in the drain wiring 121 can be given. FIG. 4A, FIG. 4B, FIG. 5A, FIG. 5B, and FIG. 5C illustrate a top view of the embodiment (2), a top view of the embodiment (3), a top view of the embodiment (4), a top view of the embodiment (5), a top view of the embodiment (6), respectively. Further, although not shown, in addition to the above embodiments, the columnar gap holding material may overlap with the expanded portion by providing an expanded portion in a capacitor wiring in a pixel.

In each of the above embodiments (2) to (6), the expanded portion 129 is not limited to the embodiments illustrated in FIGS. 4A and 4B and FIGS. 5A to 5C, as described below. In each embodiment, in addition to the embodiment in which the expanded portion 129 includes the first region 127 and the second region 128 provided in the same direction as the gate electrode 201 of the thin film transistor 113, an embodiment in which the second region 128 is provided opposite to the gate electrode 201 of the thin film transistor 113 or an embodiment in which the expanded portion 129 includes the first region 127, the second region 128, and the third region 131 may be employed. One side of the columnar gap holding material 130 is in contact with the components on the second substrate 209 and the other side of the columnar gap holding material 130 is in contact with a portion other than a step of the components over the expanded portion 129 (the expanded portion 129). Note that in each drawing, the same portions in FIG. 3A are denoted by the same reference numerals, and the same is applied to the shape and the material.

Accordingly, in the liquid crystal display device according to one embodiment of the present invention, the gap holding material does not overlap with any of a step of the components over the first substrate and a step of the components on the second substrate, whereby the gap holding materials are arranged uniformly in the pixels and sufficient mechanical reliability (mechanical strength) can be obtained.

This application is based on Japanese Patent Application serial no. 2010-221485 filed with Japan Patent Office on Sep. 30, 2010, the entire contents of which are hereby incorporated by reference.

What is claimed is:

1. An active matrix liquid crystal display device comprising:
a first substrate;
a thin film transistor over the first substrate;
a pixel electrode over the first substrate;
a second substrate facing the first substrate;
a gap holding material provided between the first substrate and the second substrate for maintaining a distance between the first substrate and the second substrate;
liquid crystal sandwiched between the first substrate and the second substrate; and
a wiring electrically connected to the thin film transistor, the wiring comprising:
a non-expanded portion; and
an expanded portion,
wherein a wiring width of the expanded portion is larger than a wiring width of the non-expanded portion, and
wherein the gap holding material overlaps with the expanded portion.

2. The active matrix liquid crystal display device according to claim 1,
wherein the expanded portion comprises;
a first region having the same wiring width as the non-expanded portion; and
a second region in contact with the expanded portion,
wherein the second region has a similar shape with a part of a top surface of the gap holding material, and
wherein an area of the second region is larger than an area of the part of the top surface of the gap holding material.

3. The active matrix liquid crystal display device according to claim 2, wherein the expanded portion further comprises a third region opposite to the second region and in contact with the first region.

4. The active matrix liquid crystal display device according to claim 3,
wherein the third region has a similar shape with a part of a top surface of the gap holding material, and
wherein an area of the third region is larger than an area of the part of the top surface of the gap holding material.

5. The active matrix liquid crystal display device according to claim 1, wherein the thin film transistor is a bottom-gate thin film transistor.

6. The active matrix liquid crystal display device according to claim 1, wherein the thin film transistor is a top-gate thin film transistor.

7. The active matrix liquid crystal display device according to claim 1, wherein the gap holding material has a cylinder shape or a prismatic shape.

8. An active matrix liquid crystal display device comprising:
a first substrate;
a thin film transistor over the first substrate;
a pixel electrode over the first substrate;
a second substrate facing the first substrate;
a gap holding material provided between the first substrate and the second substrate;
liquid crystal sandwiched between the first substrate and the second substrate; and
a gate wiring electrically connected to the thin film transistor, the gate wiring comprising:
a non-expanded portion; and
an expanded portion,
wherein a wiring width of the expanded portion is larger than a wiring width of the non-expanded portion,
wherein one side of the gap holding material is in contact with a component provided over the second substrate,
wherein the other side of the gap holding material is in contact with a component provided over the first substrate, and
wherein the gap holding material overlaps with the expanded portion.

9. The active matrix liquid crystal display device according to claim 8,
wherein the expanded portion comprises;
a first region having the same wiring width as the non-expanded portion; and
a second region in contact with the expanded portion,
wherein the second region has a similar shape with a part of a top surface of the gap holding material, and
wherein an area of the second region is larger than an area of the part of the top surface of the gap holding material.

10. The active matrix liquid crystal display device according to claim 9, wherein the expanded portion further comprises a third region opposite to the second region and in contact with the first region.

11. The active matrix liquid crystal display device according to claim 10,
wherein the third region has a similar shape with a part of a top surface of the gap holding material, and
wherein an area of the third region is larger than an area of the part of the top surface of the gap holding material.

12. The active matrix liquid crystal display device according to claim 8, wherein the thin film transistor is a bottom-gate thin film transistor.

13. The active matrix liquid crystal display device according to claim 8, wherein the thin film transistor is a top-gate thin film transistor.

14. The active matrix liquid crystal display device according to claim 8, wherein the gap holding material has a cylinder shape or a prismatic shape.

15. An active matrix liquid crystal display device comprising:
a first substrate;
a thin film transistor over the first substrate;
a pixel electrode over the first substrate;
a second substrate facing the first substrate;
a gap holding material provided between the first substrate and the second substrate;
liquid crystal sandwiched between the first substrate and the second substrate;
and a source wiring electrically connected to the thin film transistor, the source wiring comprising:
a non-expanded portion; and
an expanded portion,
wherein a wiring width of the expanded portion is larger than a wiring width of the non-expanded portion,
wherein one side of the gap holding material is in contact with a component provided over the second substrate,
wherein the other side of the gap holding material is in contact with a component provided over the first substrate, and
wherein the gap holding material overlaps with the expanded portion.

16. The active matrix liquid crystal display device according to claim 15,
wherein the expanded portion comprises;
a first region having the same wiring width as the non-expanded portion; and
a second region in contact with the expanded portion,
wherein the second region has a similar shape with a part of a top surface of the gap holding material, and
wherein an area of the second region is larger than an area of the part of the top surface of the gap holding material.

17. The active matrix liquid crystal display device according to claim 16, wherein the expanded portion further comprises a third region opposite to the second region and in contact with the first region.

18. The active matrix liquid crystal display device according to claim 17,
wherein the third region has a similar shape with a part of a top surface of the gap holding material, and
wherein an area of the third region is larger than an area of the part of the top surface of the gap holding material.

19. The active matrix liquid crystal display device according to claim 15, wherein the thin film transistor is a bottom-gate thin film transistor.

20. The active matrix liquid crystal display device according to claim 15, wherein the thin film transistor is a top-gate thin film transistor.

21. The active matrix liquid crystal display device according to claim 15, wherein the gap holding material has a cylinder shape or a prismatic shape.

22. An active matrix liquid crystal display device comprising:
a first substrate;
a thin film transistor over the first substrate;
a pixel electrode over the first substrate;
a second substrate facing the first substrate;
a gap holding material provided between the first substrate and the second substrate;
liquid crystal sandwiched between the first substrate and the second substrate; and
a drain wiring electrically connected to the thin film transistor, the drain wiring comprising:
a non-expanded portion; and
an expanded portion,
wherein a wiring width of the expanded portion is larger than a wiring width of the non-expanded portion,
wherein one side of the gap holding material is in contact with a component provided over the second substrate,
wherein the other side of the gap holding material is in contact with a component provided over the first substrate, and
wherein the gap holding material overlaps with the expanded portion.

23. The active matrix liquid crystal display device according to claim 22,
wherein the expanded portion comprises;
a first region having the same wiring width as the non-expanded portion; and
a second region in contact with the expanded portion,
wherein the second region has a similar shape with a part of a top surface of the gap holding material, and
wherein an area of the second region is larger than an area of the part of the top surface of the gap holding material.

24. The active matrix liquid crystal display device according to claim 23, wherein the expanded portion further comprises a third region opposite to the second region and in contact with the first region.

25. The active matrix liquid crystal display device according to claim 24,
wherein the third region has a similar shape with a part of a top surface of the gap holding material, and
wherein an area of the third region is larger than an area of the part of the top surface of the gap holding material.

26. The active matrix liquid crystal display device according to claim 22, wherein the thin film transistor is a bottom-gate thin film transistor.

27. The active matrix liquid crystal display device according to claim 22, wherein the thin film transistor is a top-gate thin film transistor.

28. The active matrix liquid crystal display device according to claim 22, wherein the gap holding material has a cylinder shape or a prismatic shape.
